(19) United States
(12) Patent Application Publication
(10) Pub. No.: US 2005/0251832 A1
(43) Pub. Date: Nov. 10, 2005

(54) Video acquisition and distribution over wireless networks

(76) Inventor: Tzi-cker Chiueh, East Setauket, NY (US)

Correspondence Address: F. CHAU & ASSOCIATES, LLC, 130 WOODBURY ROAD, WOODBURY, NY, 11797, US

(21) Appl. No.: 11/076,196

(22) Filed: Mar. 9, 2005

Related U.S. Application Data
(60) Provisional application No. 60/551,547, filed on Mar. 9, 2004.

(51) Int. Cl. H04N 7/173; H04N 7/16

(52) U.S. Cl. 725/62; 725/100; 725/131

(57) ABSTRACT

A system for distributing content to a mobile client includes a video acquisition server receiving a video signal and converting the video signal into a stream, and a video server connected to the video acquisition server, receiving the stream and storing the stream for real-time, on-demand video playback.

This application claims priority to U.S. Provisional Application Ser. No. 60/551,547, filed on Mar. 9, 2004, which is herein incorporated by reference in its entirety.

### BACKGROUND OF THE INVENTION

1. Field of the Invention

The present invention relates to mobile connectivity, and more particularly to a system and method for video acquisition and distribution over wireless networks.

2. Discussion of Related Art

The ability to access information at ones' convenience is a desired feature in any information disseminating system. Television is the most popular form of audio-visual information delivery system. However, television programs have fixed schedules and typically include commercial breaks in programming. Digital recorders, such as TiVo provide flexibility, enabling viewers to store television programs and play them later at their convenience. TiVo can be considered as a digital replacement of VCRs.

Berkeley Distributed Video-on-Demand is a comprehensive work about the storage aspect of large scale media contents. This system typically acts as a cache for media contents stored on tertiary storage devices. Andrew Swan and Lawrence Rowe describe a system for video content creation, encoding and distribution over mbone multicast network. Ketan Mayer-Patel et al. describe a media playback application, which can access and play remotely stored media streams. These systems, when put together form a media distribution system over multicast networks. TiVo is a device that captures analog video signals, digitizes them and stores them on local disks for future playback.

Dremedia claims to have technology that combines speech recognition, image analysis, speech-to-text transcription, and the ability to organize unstructured data. This technology may be used for making television content archived, indexed, and search-able.

However, no known system or method provides real-time retrieval from disk. Therefore, a need exists for a system and method for real-time retrieval of content from disk and streaming the content to clients.

### SUMMARY OF THE INVENTION

According to an embodiment of the present disclosure, a system for distributing content to a mobile client comprises a video acquisition server receiving a video signal and converting the video signal into a stream, and a video server connected to the video acquisition server, receiving the stream and storing the stream for real-time, on-demand video playback.

The video acquisition server is connected to a video encoder. The video acquisition server is connected to a text grabber. The video acquisition server includes a network interface for transporting the stream to the video server.

The video server includes a metadata server for managing video clip information and server information, and a push server for storing and broadcasting the stream to the mobile client demanding the stream. The metadata server includes a relational database.

The mobile client is a wireless device.

According to an embodiment of the present disclosure, a method for distributing content to a mobile client comprises receiving an encoded data stream at a video server system from an acquisition server, and storing the encoded data stream on the video server system. The method further comprises establishing a control connection between the mobile client and the video server system, and pushing the encoded data stream from the video server system to the mobile client upon receipt of a client demand via the control connection.

The method includes indexing the encoded data stream by a file identification.

The method further includes registering the acquisition server with the video server, and providing the acquisition server with a list of push servers of the video server system to which the acquisition server streams the encoded data stream.

The method includes determining a transport protocol according to a need of the mobile client.

The control connection between a wireless client and the video server system is a connection to a push server of the video server system.

The method includes establishing a control connection between the acquisition server and a metadata server of the video server system, wherein the metadata server stores information about the encoded data stream.

According to an embodiment of the present disclosure, central video server system comprises a metadata server, connected to an acquisition server, including a database of information of a data stream, and a plurality of push servers, connected to the acquisition server, to the metadata server, and to a mobile client, for storing and distributing the data stream to the mobile client.

The central video server is connected to the acquisition server and the mobile client by a communications network.

The mobile client comprises a receiver for receiving data streamed by the push server, a shared buffer connected to the receiver for storing the data, a proxy web server connected to the shared buffer for retrieving the data from the shared buffer, and a media player connected to the proxy web server by an HyperText Transfer Protocol connection for playback of the data.

### BRIEF DESCRIPTION OF THE DRAWINGS

Preferred embodiments of the present invention will be described below in more detail, with reference to the accompanying drawings:

FIG. 1 is a diagram of a system according to an embodiment of the present disclosure;

FIG. 2 is a diagram of a system according to an embodiment of the present disclosure;

FIG. 3 is an acquisition server according to an embodiment of the present disclosure;

FIG. 4 is a diagram of a video server according to an embodiment of the present disclosure;

FIG. 5 is a client according to an embodiment of the present disclosure;

FIG. 6 is a graph of a 1-Hop wireless channel when video is streamed live and on-demand using broadcast and unicast transfer mode respectively according to an embodiment of the present disclosure;

FIG. 7 is a graph of a 2-Hop wireless channel when video is streamed live and on-demand using broadcast and unicast transfer mode respectively according to an embodiment of the present disclosure; and

FIG. 8 is a flow chart of a method according to an embodiment of the present disclosure.

### DETAILED DESCRIPTION OF PREFERRED EMBODIMENTS

A multimedia distribution system streams content to clients, where the clients can use a device, such as a personal computer, to watch programs aired through diverse media, such as, cable TV, close circuit televisions, VCRs, and handheld cameras. An example of an application is the broadcasting and recording of lectures in university campuses, conferences, etc.

According to an embodiment of the present disclosure, data from a decoupled acquisition server is streamed to push servers of a video server system, which broadcast the data to mobile clients. A metadata server of the video server has a global view of the push servers and tracks metadata corresponding to video streams. The acquisition server system and mobile clients maintain a control connection, e.g., a Transmission Control Protocol (TCP) control connection, with the metadata server. The mobile clients further maintain a control connection with the push server. The mobile client may initiate a recording or playback of the video stream, which is locally stored on the push server.

It should be noted the systems and methods described herein are not limited to video as content. Rather, data including, for example, video, sound including voice communications, database information, closed-captions, etc. may be served to clients by servers.

A video server performs real-time media retrieval of content from a storage device, such as a hard disk, and transfers the content as a media stream to one or more clients on a network, e.g., a wired local area network (LAN), with real-time guarantees.

The growth of IEEE 802.11 based wireless LANs has led to hotspots for the wireless LANs on university campuses, and in hotels, airports, cafeterias, etc. Typically, portable computers, including personal digital assistants (PDAs), come equipped with some type of wireless network capability, e.g., an 802.11 network interface card. The wireless fidelity (Wi-Fi) networks enable tether-less networking by converting the last mile of a video distribution system to wireless networks. With this wireless enhanced system in place any stored program can be accessed by a client.

According to an embodiment of the present disclosure, television programs are captured, compressed in real time, stored inside a database server, and distributed over a wireless network. Real-time video broadcast on wireless networks to an end user device, e.g., desktop computer, is supported using off-the-shelf video players such as Windows Media Player. On-demand playback of a previously recorded video stream and keyboard-based query to access the previously recorded video steam are supported. Further supported is the reliable transport of video sequences over multi-hop wireless networks that are acquired through video cameras and compression hardware.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

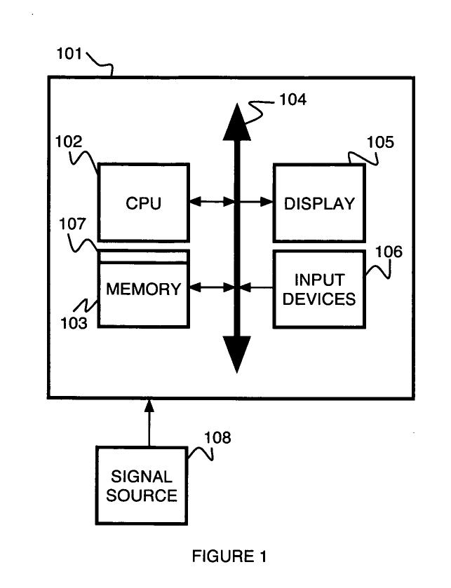

Referring to FIG. 1, according to an embodiment of the present disclosure, a computer system 101, such as a video acquisition server, video server or video client, for implementing the present invention can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Various applications are supported. For example, a central server, according to an embodiment of the present disclosure, is connected to a home entertainment system, and transmits cable television programming to multiple rooms over an 802.11 wireless LAN. According to another example, for facility security monitoring, video images captured through security cameras are relayed over multi-hop networks, and delivered on demand to security personnel over wireless networks as the security personnel move around the facility.

According to an embodiment of the present disclosure, a system can be functionally divided into three distributed components. These include, video acquisition server (AS), video server, and video client. The video acquisition server converts video signals into compressed digital streams in real-time. The video server subsystem stores and manages the compressed data on central servers for on-demand playback and transporting the data to the clients either in real-time or on-demand. The video client, connected to a LAN, accesses the streaming data in real-time or on-demand.

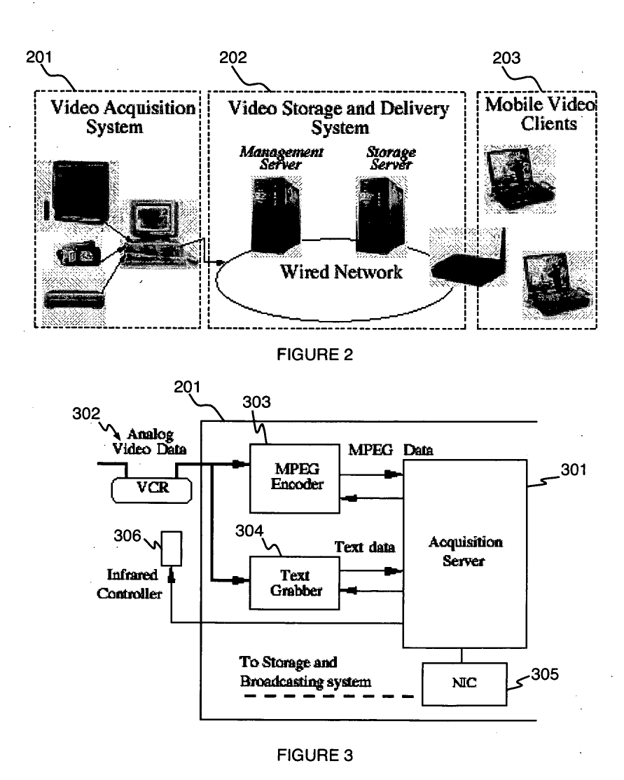

The distributed system enables mobility of the end components, e.g., the acquisition server and the client. Since, the source of video signal need not reside at a fixed location, the acquisition server may need to be mobile, and the overall system reliability and availability expectations should not be heavily dependent on it. Thus, the management and long-term storage are decoupled from the acquisition portion. The mobile clients are dynamic components of the system, which join and leave the system according to the needs of the users handling them. This shifts the burden of overall system operation onto the video server subsystem. A system architecture is shown in FIG. 2 comprising a video acquisition server system 201, a video server system 202, and a video client 203.

Referring to FIG. 3, the video acquisition server system 201 includes a video acquisition server 301. The video acquisition server 301 digitizes and compresses the analog video signals in real-time and transports the encoded streams to the central storage and/or broadcast servers for further distribution. The analog video signals can be obtained from a video source 302 such as Cable TV, for live news broadcast; a VCR, for screening of videotapes; a camcorder, for streaming live events like lectures or sports activities; or any other appropriate video source. The real-time digitization and compression is done with an encoder 303 that accepts analog video signals. Further, if the video signals carry closed-caption text, the closed-caption text is decoded by a text grabber 304 and stored along with the digitized video streams for indexing and referencing. The encoded data and text are transported to a video storage and broadcasting system over a network interface 305.

The encoder 303 can be, for example, a DarimVision MPEGator video encoder for converting an available analog composite video signal to MPEG-1 system layer streams. The video signal is also fed to a text-grabber 304, which is responsible for extracting the closed-caption text from the video signal. To facilitate the synchronization of closed-caption text with the video stream during playback at the clients, the closed-caption text is accompanied with timestamps. These timestamps may be used by clients to display the closed-caption text in synchronization with the video stream and provide a caption based video navigation.

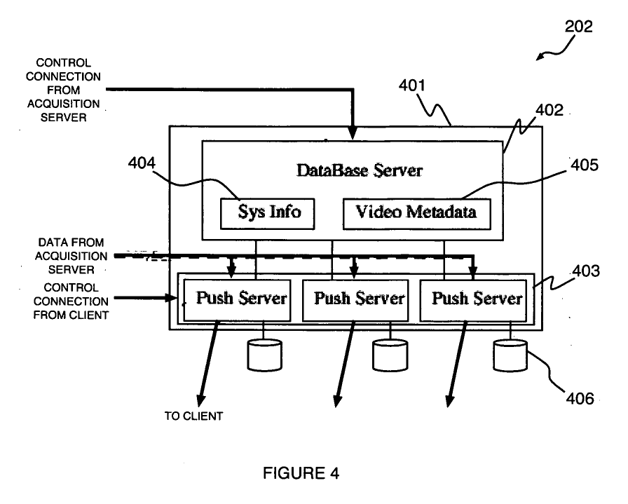

An infrared remote control device 306 can be used with the acquisition server 301, controlled by software, to tune to the desired channels. The acquisition server 301 transfers data to the storage server for possible playback in future. This data is transferred reliably. The TCP is an example of a reliable transport mechanism between the acquisition server 301 and the storage servers (see FIG. 4).

According to an embodiment of the present disclosure, one or more video acquisition servers 201 may be connected to the video server system 202 for simultaneous capture of more than one TV channels. A multiple-acquisition-server multiple-push-server architecture provides for scalability of the system.

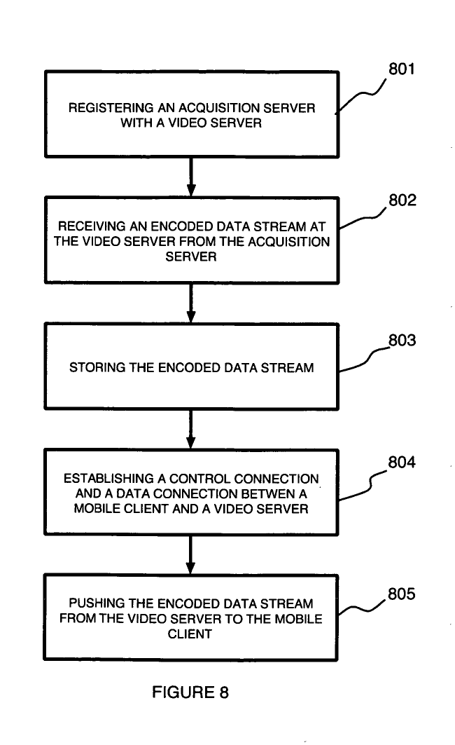

The video server system 202 is responsible for management, storage, and broadcast of the video streams and closed caption text. Referring to FIGS. 4 and 8, a video server 401 receives the encoded data and closed-caption text from the acquisition server 802, manages and stores the data centrally 803, and distributes it to the interested clients in real-time 805. The video server 401 caters to on-demand playback requests from mobile clients 203 for previously stored data. The clients 203 maintain a control connection for controlling the video server 401 and a data connection for receiving the stream from the video server 804. The video server 401 is functionally divided into a metadata server 402 and push servers 403. The metadata server 402 is responsible for management of the metadata including, video clip information 404, server information 405, etc. The push servers 403 perform the task of storing and broadcasting stream data to the clients 203. The metadata server 402 comprises a relational database. The relational database holds the information about the prerecorded media streams, their locations, closed-caption text, and the entire system configuration. The prerecorded streams are stored on storage devices 406 of the push servers 403 in the form of movie files indexed by file identifications (ids).

Upon startup, each acquisition server 301 connects to the metadata server 402 and registers with it (see FIG. 8, block 801). The metadata server 402 provides the acquisition server 301 with a list of push servers 403 to which it needs to stream the encoded data. From this point onwards, the acquisition server 301 is treated as one of the channels in the distribution system. The push servers 403 are responsible for transferring the video data to the mobile clients using appropriate transport protocols. The push servers 403 also store the video locally for future on-demand playback. Push servers 403 use local disks 406 for storing data. A separate storage component can be implemented from the streaming subsystem by making use of network attached storage such as Phoenix, which is designed specifically for video storage and proves QoS guarantees.

For the streaming of real-time data to the mobile video clients 203 over wireless links, the push servers 403 are responsible for broadcasting data over the last mile of the entire network. For performance reasons, push servers 403 reside in the wired segment of the network. However, the real-time streaming of data is done over the wireless network. There are three options that can be considered for data transmission. These include, unicast transmission to each interested client, multicast transmission to only interested clients, and broadcast to all the clients and the clients can do further processing to filter out the required data. The data transmission can be carried out in an infrastructure setup of WLANs, which is a single hop wireless network. Alternatively, the data can also be transmitted over a multi-hop wireless setup in order to increase the reachability and quality of transmission by increasing the density of repeaters. The maximum bandwidth of Wi-Fi networks is 11 Mbps and the observed available bandwidth is merely 6 Mbps. The average bandwidth requirement of MPEG-1 system stream is about 1.5 Mbps. Given these statistics, a maximum of four clients can be supported in any wireless network segment if unicast transmission is adopted. Further, these clients cannot have any QoS guarantees.

An improved choice of data transmission uses multicast addresses where multicast groups are established corresponding to each channel and mobile clients can join and leave these multicast groups according to the requirements. This enables providing content to up to four different channels in any given wireless segment with no restriction on the maximum number of clients. This option can lack uniform and well documented multicast support by Wi-Fi hardware vendors. There is no clear and general mechanism that is made available by the NIC device driver to the operating system to join or leave a multicast group. Accordingly, a further improvement uses broadcast addressing to reach the mobile clients. It is possible to send broadcast packets and still stream multiple channels in a wireless LAN segment. This can be done by sending User Datagram Protocol (UDP) datagrams to a broadcast Internet Protocol (IP) address and destined to specific ports. The destination ports distinguish one media channel from other. Using this technique up to four channels can be streamed in a wireless segment without any limitation on the number of clients.

According to 802.11b specifications, broadcast packets are categorized under asynchronous data services. Asynchronous data services may experience lower quality of service compared to other packets. 802.11b specifications, in addition to an acknowledgement (ACK) mechanism, also describe a fragmentation/defragmentation mechanism to increase reliability, by increasing the probability of successful transmission of the packet in cases where channel characteristics limit reception reliability for longer frames. But this ACK based reliability and fragmentation may not be applicable for broadcasting packets. Owing to these issues, the wireless segment is able to handle up to two video channels in a reliable manner. This is an improvement over using unicast addresses as the possible number of clients can still be very high without loading the wireless network. According to an embodiment of the present disclosure, push servers receive the data from acquisition servers over TCP connections. Since the data arrives from a remote location, any periodicity introduced in transmissions by the acquisition servers may not be observed at the push server end. To avoid jitters and effects of network push servers introduce pacing in the broadcast traffic by transmitting the received data in a streamed fashion to avoid bursty traffic on the wireless LAN.

The video client application runs on an end host or client 203. The video client application plays streaming video in real-time and playback prerecorded programs on-demand. On startup, clients fetch the list of active channels that are being streamed live and the list of the pre-recorded programs from the metadata server. For live streaming, selection of a particular channel implies listening on a port on which a push server is broadcasting the video. In case of playback, the client 203 retrieves the closed captions corresponding to the video clip, and the video segment is unicast to each client.

A caption-based video navigation interface running on a video client 203 provides both a time-based access and a keyword-based access to the stored video streams, through for example a graphical user interface including appropriate textboxes. These access techniques may be used to browse and access a large-scale video archive.

Within the caption-based video navigation interface the closed captions are highlighted, for example in a textbox, in a time-synchronized manner along with the video clip. The closed captions are retrieved fully before starting the playback to provide a text-based navigation facility through the video clip for the user. One can jump to the portion of the video clip corresponding to a caption text by clicking on the caption in the textbox. Searching for keywords from the captions is also possible.

The video client software can be implemented on Windows platform and uses Windows Media Player (WMP) for displaying the MPEG streams. The choice of WMP is driven by the widespread use of the Windows platform for portable devices and personal computers at homes. However, other platforms, such as Linux, can be implemented as a video client. The media player supports a set of protocols for streaming media. For playing streaming media on WMP, the video streaming server either uses Microsoft Media Server (MMS) protocol or it can be transferred from a web server using the HyperText Transfer Protocol (HTTP). The push server can use UDP for broadcast and unicast playback. The media player may need a specific header to be able to select the decoder for the MPEG stream. However, for real-time streaming this header is not present in the stream.

The use of the proxy server 502 at the video client 203 enables video broadcasting/unicasting over a wireless network. Media players such as WMP are not designed to receive broadcast/multicast streams. The proxy 502 serves as an adapter between a broadcast/multicast stream of the video server system 202 and an HTTP-based video stream that commercial media players expect. This broadcast/multicast capability, e.g., UDP to HTTP conversion at the client, allows for reduced bandwidth consumption between the video server system 202 and the client 203 as compared to an HTTP connection.

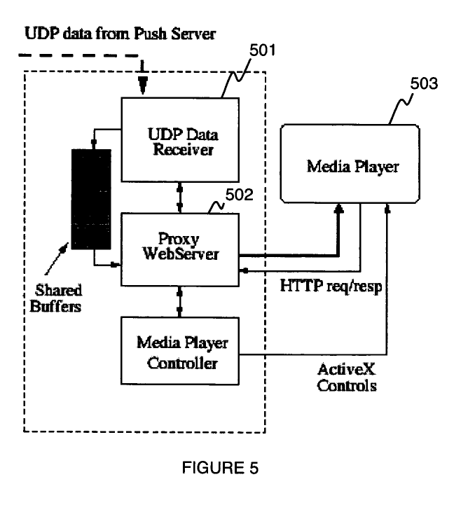

To circumvent the problem of limited streaming protocols and enable broadcast/unicast reception over UDP, the client software comprises three logical components. Referring to FIG. 5, these components include a receiver back-end, which receives UDP data streamed by push server and puts it in a shared buffer, a lightweight proxy web server 502, which retrieves this data from the shared buffer and sends it to the media player using HTTP, and an embedded media player 503, such as the WMP, in the MFC-based client application which uses ActiveX control interfaces. For the WMP, the use of the proxy web server 502 solves the problem of streaming because WMP can interpret streams over HTTP connection. The client software and the protocols are used to communicate between the push server and the receiver, and the web proxy 502 and the media player 503.

By way of an example, for the WMP, the header needed by the WMP for decoding and displaying the MPEG streams correctly is the initial MPEG pack header that is created during an encoding process. The push server caches the pack header for each encoded stream. When a client requests live streaming or playback, it fetches the header and sends it to the media player. This allows the WMP to decode and playback the video stream correctly.

Wireless environments are inherently lossy. Frame loss may lead to a desynchronization in display of caption and video together. To resynchronize, timestamps are used on the captions and the packets sent from the push server. In the event of losses we jump through the caption display corresponding to the lost video frames.

A system architecture according to an embodiment of the present disclosure may comprise multiple logical components; whether they are implemented on separate machines depends on specific application needs. For an enterprise-scale video delivery system, the video storage and management server may be separated from the acquisition server because multiple acquisition servers may be needed to capture different types of video streams, e.g., TV programs, live lectures, etc. However, for a home entertainment server, the video storage and management server and the acquisition server can be packaged into a single box. The ability to distribute video over wireless LAN is particularly compelling because desktop machines are increasingly being replaced by laptop computers and many laptop machines come with a built-in wireless LAN interface. As a result, a home entertainment server based on an embodiment of the present disclosure allows each household member to watch his/her favorite show from the desktop/laptop in his/her room.

A digital video recorder (DVR), such as a TiVo machine, can be implemented as a platform for developing such home entertainment servers. A DVR can digitize and compress analog video into MPEG-2 video streams, and store them into disk storage for later playback, all in real time. In addition, DVR boxes are relatively inexpensive compared with standard PC servers. Most importantly, it is known in the DVR community that a DVR can be extended with an adapter that in turn connects to an Ethernet interface or an 802.11 interface. With this extensibility, one can run a video acquisition server and video storage and management server on, for example, a TiVo machine, and distribute the stored video streams through a wireless link in a near-real-time fashion. Because one can also add additional memory and disks to a DVR machine, storage resources are not limiting. Finally, the fact that certain DVRs, such as a TiVo machine, also run Linux makes porting possible.

Experiments have been implemented using notebook computers as mobile clients with Intel Pentium class processors running Microsoft® Windows® [XP/ME/98] operating systems (OS) with RAM varying from 64 megabytes (MB) to 256 MB. The mobile clients used in the experiments included Orinoco wireless cards as their NICs (Network Interface Cards).

An acquisition server according to an embodiment of the present disclosure, was implemented and installed on a Pentium®-II 400 MHz PC with 128 MB RAM and Windows® ME as the OS. The acquisition server was connected to the central metadata server and push servers through a high-speed campus-wide wide area network (WAN). The input for MPEGator board comes from campus cable TV system.

The metadata server was implemented on a Pentium®-IV 1800 MHz machine with 256 MB of RAM with Linux Red Hat 9.0 OS. The back-end relational database is Postgres and the front-end database application is implemented in JAVA and uses JDBC (Java Database Connectivity) to interface with the database.

The system configuration of push servers was similar to metadata server. Push servers were Pentium®-IV 1600 MHz machines with 128 MB or RAM with Linux Redhat 9.0 OS. Push servers used IDE (Integrated Disk Electronics) disks to store the recordings of video streams.

Push servers, metadata server, and wireless network access points were connected with each other by a 100 Mbps Fast Ethernet switched network.

To understand the usability of the system in an exemplary environment, the playback and live streaming capabilities of the system on wired were studied, as well as on 1-hop and 2-hop wireless LAN setup. In the wired case, there was no perceived loss of packet on client and both the live streaming and playback with captions were smooth. Wireless LAN is inherently prone to packet loss. In Table I, a relationship between the number of packets lost in burst and the perceived quality of video is shown.

TABLE I

| Loss Size | Slow-Clipping | Fast-Clipping |
|---|---|---|
| (packets) | Clip | Clip |
| 1-3 | Acceptable | Minor perceptible |
| | | glitches |
| 4-6 | Minor glitches | Noticeable |
| | | glitches |
| 7-10 | Noticeable glitches | Video stalls on |
| | | loss |
| 10+ | Unacceptable | Unacceptable |
| | glitches | pauses and clicks |

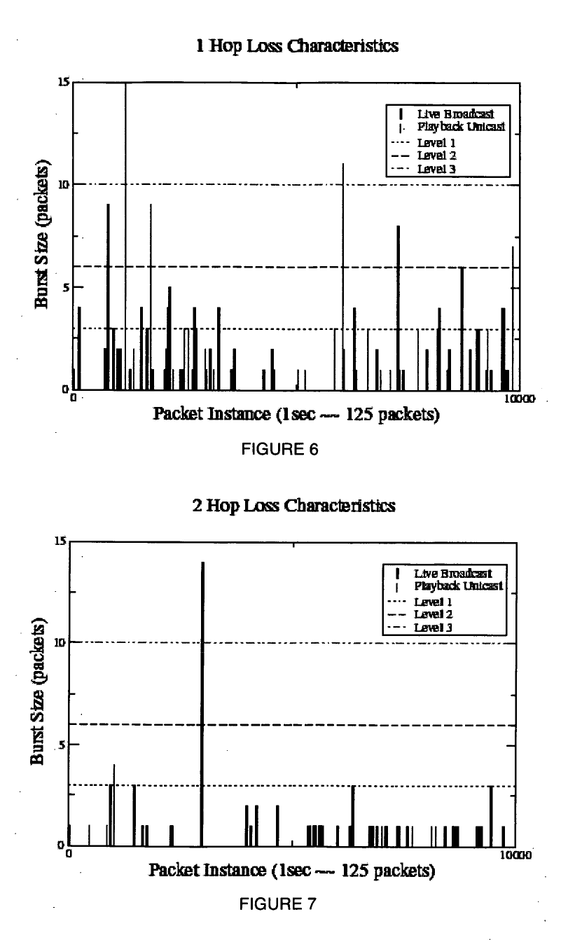

FIG. 6 shows the packet loss characteristics of a 1-Hop wireless channel when streaming live data and on-demand playback. The distribution server was positioned in a room separated by two walls from the client. The difference between the two cases is in terms of using broadcast and unicast respectively. As shown in FIG. 6, a majority of the losses in broadcast are confined to a burst loss of less than 10 packets. Hence, live streaming despite having few glitches give acceptable video quality. In unicast there are a few large packet losses. However, mostly the losses stay within 10 packets and are comparatively fewer leading to a better perceived quality than that of broadcast. The different levels shown in FIG. 6 correspond to different perceived qualities described in Table I.

FIG. 7 shows similar characteristics for a 2-Hop channel. An additional repeater was positioned in between the client and the distribution server. The transmission characteristics were improved because of the additional repeater and the perceived quality of video was observed to be better than the 1-Hop case.

A scalability analysis of the number of possible channels over wireless LANs was also performed. It was possible to broadcast two channels with acceptable quality. The observed video quality deteriorated when the number of channels was increased to three. With four channels the observed quality was unacceptable. Thus up to 3 channels can be supported over a wireless LAN using a single channel.

According to an embodiment of the present disclosure, horizontal handoff and vertical handoff technology may be implemented for maintaining connectivity between a video server and video client. Methods for performing horizontal handoff are well known. A low-latency network-layer vertical handoff may leverage Mobile IP, WWAN (Wireless Wide Area Network) dial-up server, and PAP (Password Authentication Protocol) stack. The vertical handoff system may include a WLAN (Wireless Local Area Network) link status monitor on the mobile node that determines when to switch from WLAN to WWAN and when to switch from WWAN to WLAN to minimize WAN (Wide Area Network) connectivity charges. Vertical handoff is more general and flexible than commercial disk-based VCRs, and supports wireless video multiple users simultaneously.

Having described embodiments for a system and method for video acquisition and distribution over wireless networks, it is noted that modifications and variations can be made by persons skilled in the art in light of the above teachings. It is therefore to be understood that changes may be made in the particular embodiments of the invention disclosed which are within the scope and spirit of the invention.

1. A system for distributing content to a mobile client comprising:
a video acquisition server receiving a video signal and converting the video signal into a stream; and
a video server connected to the video acquisition server, receiving the stream and storing the stream for real-time, on-demand video playback.

2. The system of claim 1, wherein the video acquisition server is connected to a video encoder.

3. The system of claim 1, wherein the video acquisition server is connected to a text grabber.

4. The system of claim 1, wherein the video acquisition server includes a network interface for transporting the stream to the video server.

5. The system of claim 1, wherein the video server includes a metadata server for managing video clip information and server information, and a push server for storing and broadcasting the stream to the mobile client demanding the stream.

6. The system of claim 5, wherein the metadata server includes a relational database.

7. The system of claim 1, wherein the mobile client is a wireless device.

8. A method for distributing content to a mobile client comprising:
receiving an encoded data stream at a video server system from an acquisition server;
storing the encoded data stream on the video server system;
establishing a control connection between the mobile client and the video server system; and
pushing the encoded data stream from the video server system to the mobile client upon receipt of a client demand via the control connection.

9. The method of claim 8, further comprising indexing the encoded data stream by a file identification.

10. The method of claim 8, further comprising:
registering the acquisition server with the video server; and
providing the acquisition server with a list of push servers of the video server system to which the acquisition server streams the encoded data stream.

11. The method of claim 8, further comprising determining a transport protocol according to a need of the mobile client.

12. The method of claim 8, wherein the control connection between a wireless client and the video server system is a connection to a push server of the video server system.

13. The method of claim 8, further comprising establishing a control connection between the acquisition server and a metadata server of the video server system, wherein the metadata server stores information about the encoded data stream.

14. A central video server system comprising:
a metadata server, connected to an acquisition server, including a database of information of a data stream; and
a plurality of push servers, connected to the acquisition server, to the metadata server, and to a mobile client, for storing and distributing the data stream to the mobile client.

15. The central video server system of claim 14, wherein the central video server is connected to the acquisition server and the mobile client by a communications network.

16. The central video server of claim 14, wherein the mobile client comprises:
a receiver for receiving data streamed by the push server;
a shared buffer connected to the receiver for storing the data;
a proxy web server connected to the shared buffer for retrieving the data from the shared buffer; and
a media player connected to the proxy web server by an HyperText Transfer Protocol connection for playback of the data.
